(19) United States
(12) Patent Application Publication
(10) Pub. No.: US 2007/0289801 A1
(43) Pub. Date: Dec. 20, 2007

(54) CONTROL APPARATUS FOR A VEHICLE

(75) Inventors: Larry Dean Potter, Maiden, NC (US); Ronald Lynn May, Maiden, NC (US)

Correspondence Address: ADAMS EVANS P.A., Suite 2350 Charlotte Plaza, 201 South College Street, CHARLOTTE, NC, 28244, US

(73) Assignee: ARGES MANUFACTURING, INC., Maiden, NC (US)

(21) Appl. No.: 11/424,054

(22) Filed: Jun. 14, 2006

(51) Int. Cl. B62D 1/22

(52) U.S. Cl. 180/322

(57) ABSTRACT

A control apparatus having a moveable steering console for vehicles. The steering console includes a steering a steering platform carried by and moveable relative to the vehicle. The steering platform includes a steering device for receiving a user input, a moving means operably connected to the steering device for moving the steering platform in response to the user input, and a directing means for receiving the user input and selectively directing the user input to the moving means.

### TECHNICAL FIELD AND BACKGROUND OF THE INVENTION

The present invention relates to the field of control apparatuses for a vehicle. In particular, the invention relates to a control apparatus having a moveable steering console.

Steering consoles are well-known in the art. Typically, steering consoles are fixed in position so that an operator positioned in a driver's seat is centered with the steering console to drive the vehicle in a comfortable position. Sometimes, it is necessary for the operator to closely watch the location of a side of the vehicle, thereby requiring the operator to lean over the side or out of the seat. Over long periods of time this can be very uncomfortable.

For example, an operator of a piece of prior art construction machinery, such as a paving roller, needs to be able to watch an outside edge of the drum of the roller when rolling over pavement along an edge. To do this, the operator must lean outwardly over a side of the roller and reach back to the steering console to control the direction of the roller. As a result, the operator is improperly positioned on the roller, causing soreness, fatigue, and/or injury to the operator.

Accordingly, there is a need for a steering console that allows an operator to be properly positioned on a vehicle for controlling the vehicle and centered with the steering console.

### SUMMARY OF THE INVENTION

Therefore it is an object of the invention to provide a steering console that is moveable.

It is another object of the invention to provide a steering console that uses a steering input to move to the console to a desired location.

It is another object of the invention to provide a steering console that allows an operator to remain properly positioned on a vehicle during operation.

These and other objects of the present invention are achieved in the preferred embodiments disclosed below by providing a control apparatus for a vehicle including a steering platform carried by and moveable relative to the vehicle. The steering platform includes a steering device for receiving a user input, a moving means operably connected to the steering device for moving the steering platform in response to the user input, and a directing means for receiving the user input and selectively directing the user input to the sliding means.

According to another preferred embodiment of the invention, and further including a steering means operably connected to the steering device to provide a steering force in response to the user input.

According to another preferred embodiment of the invention, the directing means selectively directs the user input to the steering means.

According to another preferred embodiment of the invention, the directing means includes an actuator for selectively directing the user input to the moving means.

According to another preferred embodiment of the invention, the directing means includes an actuator for selectively directing the user input between the moving means and the steering means.

According to another preferred embodiment of the invention, a control apparatus for a vehicle includes a steering platform carried by the vehicle and adapted for movement between a first controlled position and a second controlled position for allowing an operator to be positioned proximate an edge of the vehicle. The steering platform includes a steering device for receiving a user input, a moving means operably connected to the steering device for moving the platform in response to the user input, and a directing means for receiving the user input and selectively directing the user input to the moving means.

According to another preferred embodiment of the invention, a control apparatus for a vehicle includes a steering platform carried by and laterally moveable relative to the vehicle. The steering platform includes a steering device operably connected to a pump for receiving a user input, a moving means for moving the steering platform laterally in response to the user input, and a valve for receiving pressurized fluid from the pump in response to the user input. The steering means provides a steering force in response to the user input. The valve selectively directs the pressurized fluid either to the steering means or the moving means.

According to another preferred embodiment of the invention, the steering device is a steering wheel.

According to another preferred embodiment of the invention, the valve includes an actuator for selectively directing the user input between the moving means and the steering means.

According to another preferred embodiment of the invention, and further including at least one rail attached to the vehicle.

According to another preferred embodiment of the invention, the steering platform is slidably attached to the at least one rail to allow the steering platform to move laterally relative to the vehicle.

According to another preferred embodiment of the invention, the steering platform is attached to the at least one rail by a collar connected to the steering platform and adapted slide along the at least one rail.

According to another preferred embodiment of the invention, a control apparatus for a vehicle including a steering console mounted to the vehicle. The console includes at least one rail and a steering platform slidably attached to the at least one rail for lateral movement relative to the vehicle. The steering platform includes a steering device operably connected to a pump for receiving a user input, a motor in mating engagement with a gear for moving the steering platform laterally in response to the user input, and a valve for receiving pressurized fluid from the pump in response to the user input. The steering means provides a steering force in response to the user input. The valve selectively directs the pressurized fluid either to the steering means to provide the steering force or to the motor to move the steering platform laterally.

According to another preferred embodiment of the invention, the pump supplies the pressurized fluid to the valve in response to the steering device.

According to another preferred embodiment of the invention, when the valve directs the pressurized fluid to the steering means the steering device steers the vehicle.

According to another preferred embodiment of the invention, when the valve directs the pressurized fluid to the motor the steering device causes the steering platform to slide along the at least one rail.

According to another preferred embodiment of the invention, the valve includes an actuator for selectively directing the user input between the motor and the steering means.

According to another preferred embodiment of the invention, the motor is driven by the pressurized fluid.

### BRIEF DESCRIPTION OF THE DRAWINGS

The invention may be best understood by reference to the following description in conjunction with the accompanying drawing figures in which:

FIG. 1 shows a vehicle with a control apparatus according to an embodiment of the invention;

FIG. 2 shows the vehicle and control apparatus of FIG. 1 from a partial front perspective view;

FIG. 3 shows a console of the control apparatus of FIG. 1;

FIG. 4 shows a motor for moving the console of FIG. 3;

FIG. 5 is a schematic showing the motor of FIG. 4 moving a platform of the console of FIG. 3;

FIG. 6 is a schematic of a hydraulic system for the control apparatus of FIG. 1;

FIG. 7 shows the console of FIG. 3 in a centered seating position;

FIG. 8 shows the console of FIG. 3 in a left seated position; and

FIG. 9 shows the console of FIG. 3 in a right seated position;

### DESCRIPTION OF THE PREFERRED EMBODIMENT AND BEST MODE

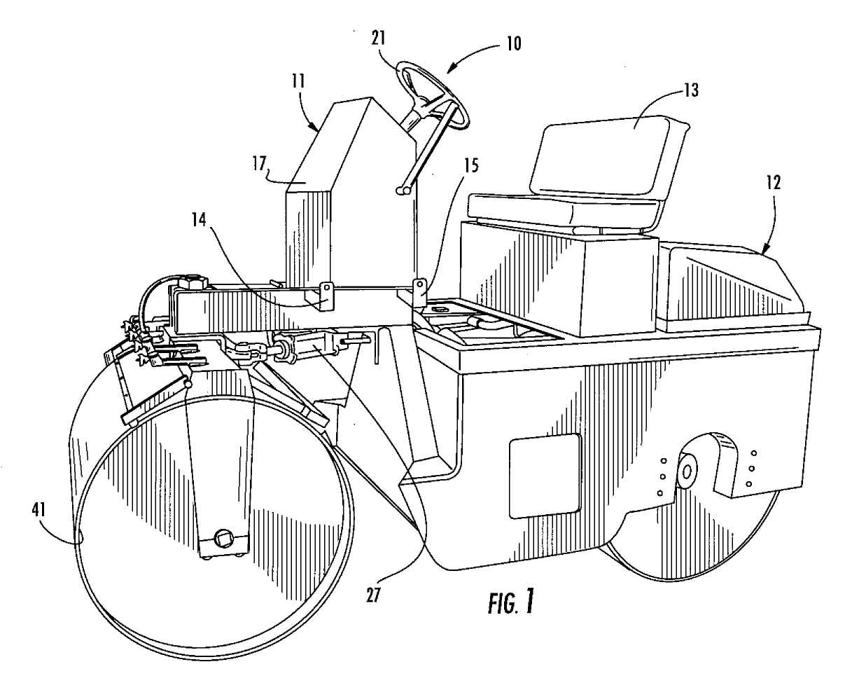

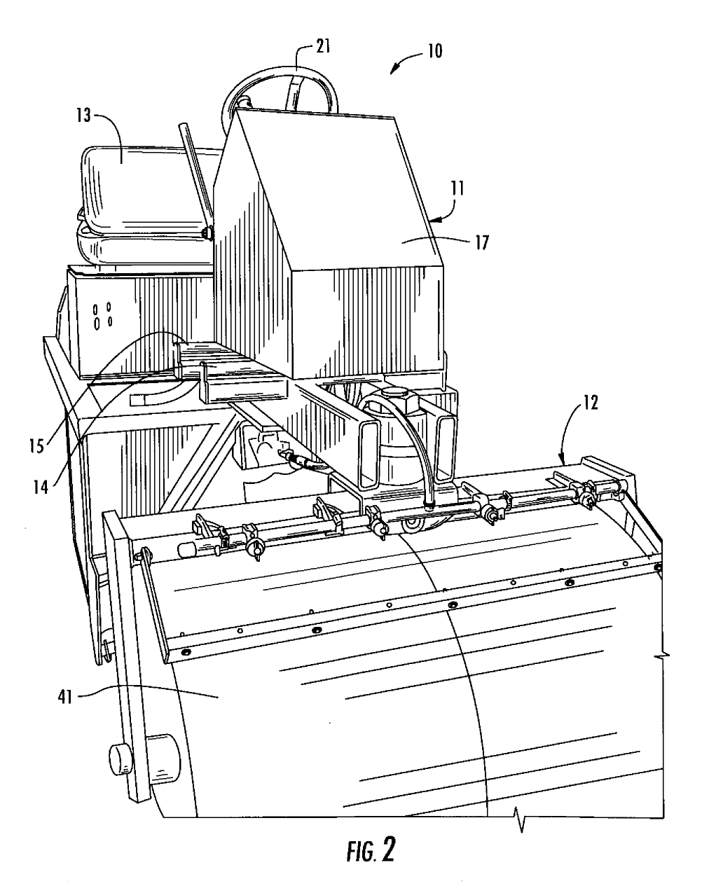

Referring now specifically to the drawings, a control apparatus having a moveable steering console 11 according to an embodiment of the invention is illustrated in FIGS. 1 and 2 and shown generally at reference numeral 10. The steering console 11 is mounted to a vehicle, such as a paving roller 12, for movement relative to an operator seat 13 to allow an operator to remain centered with the steering console 11 regardless of where the operator is seated. For discussion purposes, the steering console 11 will be discussed in reference to the roller 12; however, it should be appreciated that the steering console 11 may be used with other types of vehicles, as well. It should also be appreciated that while the invention is being described with reference to a hydraulic system, systems using electronic, electrical, and pneumatic components, or a combination of these systems, could also be used to send signals that cause actuators, motors, or pumps to move the steering console 10 or operate the vehicle.

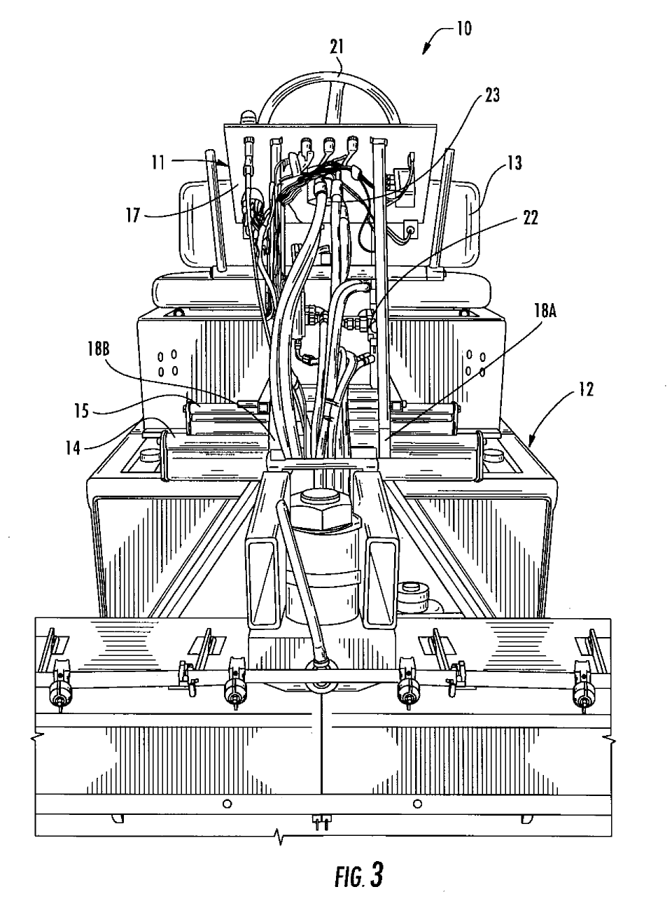

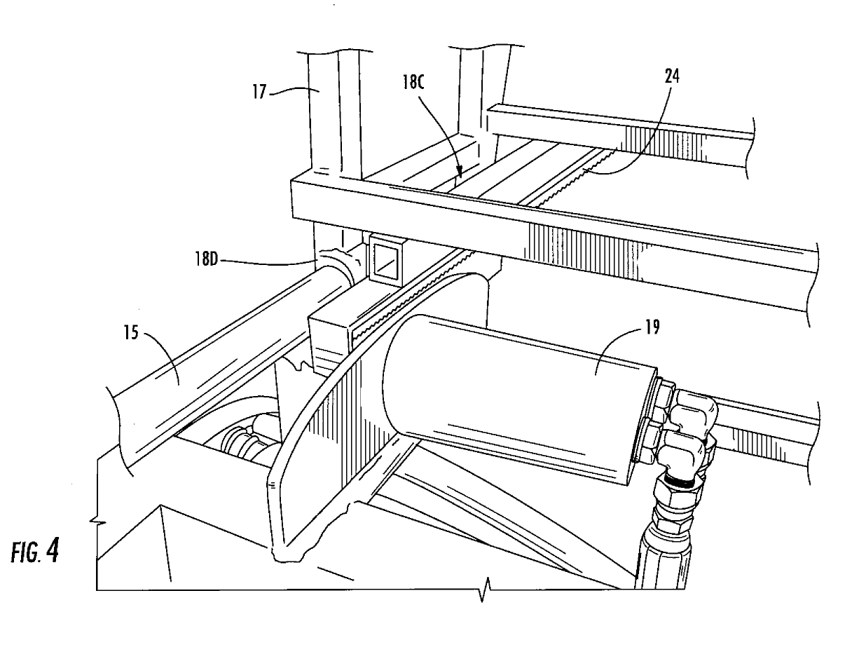

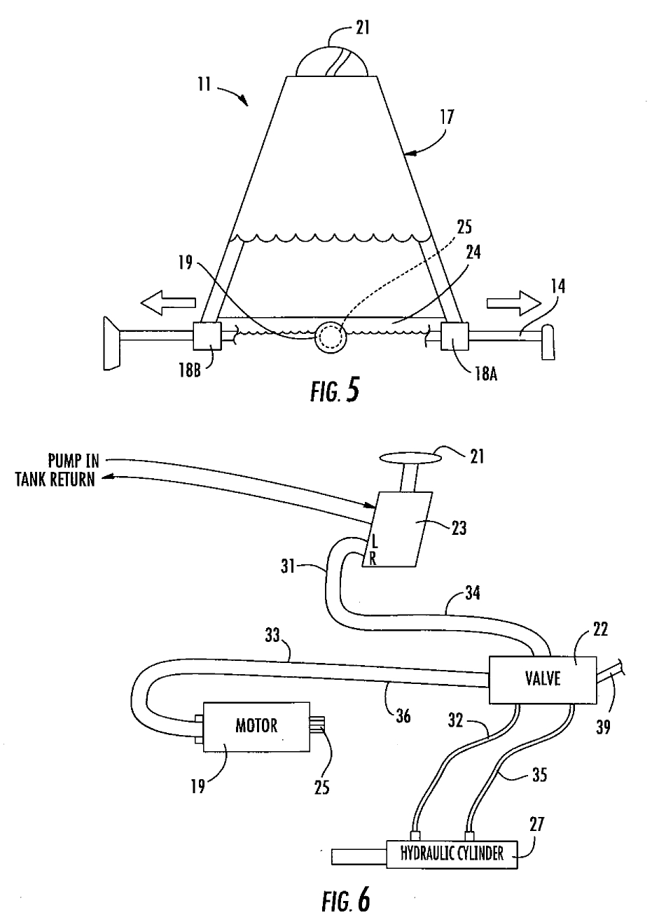

Referring to FIG. 3, the steering console 11 includes a pair of spaced-apart rails 14 and 15 connected to the roller 12 and positioned relative to the seat 13, a steering platform 17 moveably connected to the rails 14 and 15 by collars 18A-18D, and a motor 19, shown in FIG. 4, for moving the steering platform 17 along the rails 14 and 15. The steering platform 17 includes a steering device, such as a steering wheel 21 or joystick, a three-way valve 22 for switching between a steering mode and a moving mode, a pump 23 operably connected and responsive to the steering wheel 21, and a gear 24 in mating engagement with a gear 25, as illustrated in FIG. 5, of the motor 19 for moving the steering platform 17 along the rails 14 and 15.

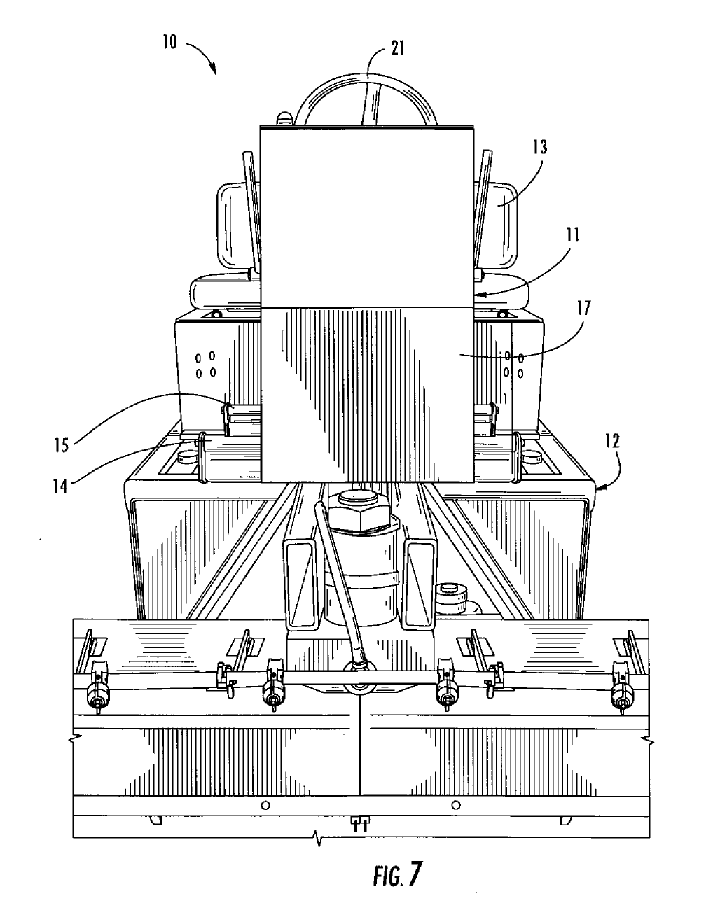

Referring to FIG. 6, the pump 23, valve 22, motor 19, and a hydraulic steering cylinder 27 are operably connected to each other by hoses, shown in FIG. 3, that define left steer hoses 31, 32, and 33 and right steer hoses 34, 35, and 36. The valve 22 controls the flow of pressurized hydraulic fluid from the pump 23 to either the motor 19 or the steering cylinder 27. An actuator 39 allows an operator to switch the valve 22 between the steering mode and the moving mode. As illustrated, the actuator 39 is a lever attached to the valve 22, but other actuators, such as a button positioned next to the steering wheel 21 may be used. In steering mode, the pump 23 delivers pressurized hydraulic fluid to the steering cylinder 27 via the valve 22, and in moving mode, the pump 23 delivers pressurized hydraulic fluid to the motor 19 via the valve 22.

In operation, if the operator wants to steer the roller 12, the operator uses the actuator 39 to switch the valve 22 into steering mode. The operator then uses the steering wheel 21 to steer the roller 12. To turn the roller 12 to his/her right, the operator moves the steering wheel 21 accordingly, causing the pump 23 to deliver hydraulic fluid to the valve 22 via right steer hose 34 and then to steering cylinder 27 via right steer hose 35. The steering cylinder 27 then expands/retracts to move drum 41 in a direction to turn the roller 12 to the right. To turn the roller to the left, the operator turns the steering wheel 21 accordingly to cause the pump 23 to deliver hydraulic fluid to the valve 22 via left steer hose 31 and then to steering cylinder 27 via left steer hose 32.

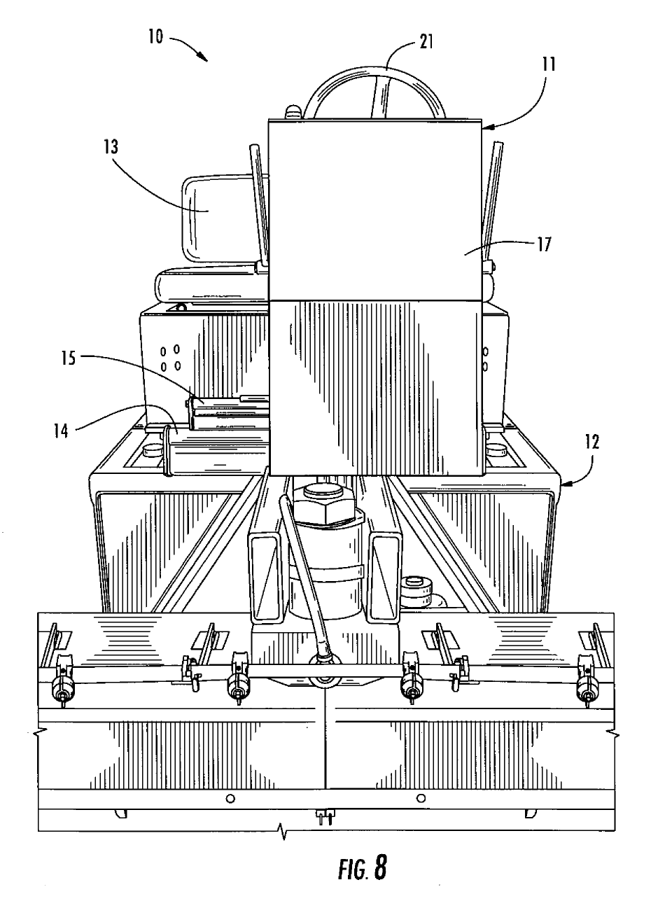

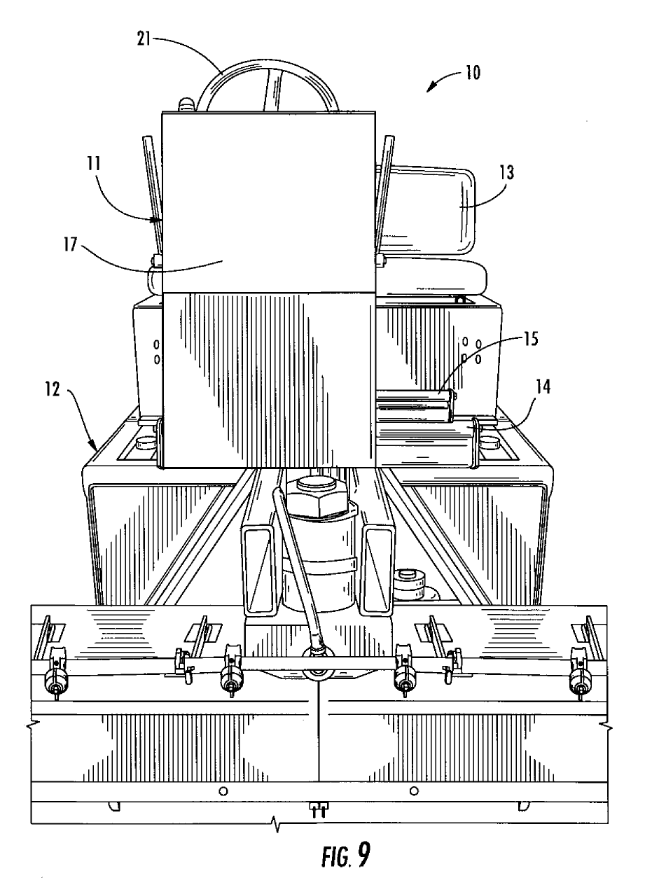

If the operator wants to move from a centered seating position, shown in FIG. 7, to a left seated position, shown in FIG. 8, to a right seated position, shown in FIG. 9, or anywhere in between, the operator uses the actuator 39 to switch the valve 22 into a moving mode where the steering platform may slid, pivoted, or translated. The operator then uses the steering wheel 21 in the same manner as he/she would if steering the roller 12.

To move the steering platform 17 to the left seated position, FIG. 8, the operator uses the steering wheel 21 as if he/she were steering the roller 12 to the left. The pump 23 then delivers hydraulic fluid to the valve 22 via left steer hose 31 and then to the motor 19 via left steer hose 33, causing the motor 19 to rotate gear 25 which engages gear 24 to move the steering platform 17 to the left. To move the steering platform 17 to the right seated position, FIG. 9, the operator uses the steering wheel 21 as if he/she were steering the roller 12 to the right. The pump 23 then delivers hydraulic fluid to the valve 22 via right steering hose 34 and then to the motor 19 via right steering hose 36, causing the motor 19 to rotate gear 25 which engages gear 24 to move the steering platform 17 to the right. By moving the steering platform 17 along the rails 14 and 15, the steering platform 17 can be centered and positioned in front of the operator. Once the steering platform 17 has been properly positioned in front of the operator, the actuator 39 may be used to switch the valve 22 into steering mode, thereby allowing the operator to steer the roller 12.

While movement of the steering platform 17 has been described in a left to right relation, it should be appreciated that the steering platform could also be moved in a forward to rearward relation, pivoted, or any other direction by rotating or moving the position of the rails 14 and 15.

A control apparatus having a moveable steering console is described above. Various details of the invention may be changed without departing from its scope. Furthermore, the foregoing description of the preferred embodiments of the invention and best mode for practicing the invention are provided for the purpose of illustration only and not for the purpose of limitation.

We claim:

1. A control apparatus for a vehicle, comprising:
(a) a steering platform carried by and moveable relative to the vehicle, the steering platform including a steering device for receiving a user input; a moving means operably connected to the steering device for moving the platform in response to the user input; and a directing means for receiving the user input and selectively directing the user input to the moving means.

2. The control apparatus according to claim 1, and further including a steering means operably connected to the steering device for providing a steering force in response to the user input.

3. The control apparatus according to claim 2, wherein the directing means selectively directs the user input to the steering means.

4. The control apparatus according to claim 1, wherein the directing means includes an actuator for selectively directing the user input to the moving means.

5. The control apparatus according to claim 3, wherein the directing means includes an actuator for selectively directing the user input between the moving means and the steering means.

6. A control apparatus for a vehicle, comprising:
(a) a steering platform carried by the vehicle and adapted for movement between a first controlled position and a second controlled position for allowing an operator to be positioned proximate an edge of the vehicle, the steering platform including a steering device for receiving a user input; a moving means operably connected to the steering device for moving the platform in response to the user input; and a directing means for receiving the user input and selectively directing the user input to the moving means.

7. The control apparatus according to claim 6, and further including a steering means operably connected to the steering device for providing a steering force in response to the user input.

8. The control apparatus according to claim 7, wherein the directing means includes an actuator for selectively directing the user input between the moving means and the steering means.

9. A control apparatus for a vehicle, comprising:
(a) a steering platform carried by and laterally moveable relative to the vehicle, the steering platform including:
(i) a steering device operably connected to a pump for receiving a user input;
(ii) a moving means for moving the steering platform laterally in response to the user input; and
(iii) a valve for receiving pressurized fluid from the pump in response to the user input;
(b) a steering means for providing a steering force in response to the user input; and
(c) wherein the valve selectively directs the pressurized fluid either to the steering means or the moving means.

10. The control apparatus according to claim 9, wherein the steering device is a steering wheel.

11. The control apparatus according to claim 9, wherein the valve includes an actuator for selectively directing the user input between the moving means and the steering means.

12. The control apparatus according to claim 9, and further including at least one rail attached to the vehicle.

13. The control apparatus according to claim 12, wherein the steering platform is slidably attached to the at least one rail to allow the steering platform to move laterally relative to the vehicle.

14. The control apparatus according to claim 13, wherein the steering platform is attached to the at least one rail by a collar connected to the steering platform and adapted to slide along the at least one rail.

15. A control apparatus for a vehicle, comprising:
(a) a steering console mounted to the vehicle and including at least one rail and a steering platform slidably attached to the at least one rail for lateral movement relative to the vehicle, the steering platform including:
(i) a steering device operably connected to a pump for receiving a user input;
(ii) a motor in mating engagement with a gear for moving the steering platform laterally in response to the user input; and
(iii) a valve for receiving pressurized fluid from the pump in response to the user input;
(b) a steering means for providing a steering force in response to the user input; and
(c) wherein the valve selectively directs the pressurized fluid either to the steering means to provide the steering force or to the motor to move the steering platform laterally.

16. The control apparatus according to claim 15, wherein the pump supplies the pressurized fluid to the valve in response to the steering device.

17. The control apparatus according to claim 15, wherein when the valve directs the pressurized fluid to the steering means the steering device steers the vehicle.

18. The control apparatus according to claim 15, wherein when the valve directs the pressurized fluid to the motor the steering device causes the steering platform to slide along the at least one rail.

19. The control apparatus according to claim 18, wherein the valve includes an actuator for selectively directing the user input between the motor and the steering means.

20. The control apparatus according to claim 18, wherein the motor is driven by the pressurized fluid.
